(19) United States
(12) Patent Application Publication
(10) Pub. No.: US 2024/0371151 A1
(43) Pub. Date: Nov. 7, 2024

(54) LEARNING APPARATUS, LEARNING METHOD AND PROGRAM

(71) Applicant: NIPPON TELEGRAPH AND TELEPHONE CRPORATION, Tokyo (JP)

(72) Inventors: Yoko SOGABE, Musashino-shi (JP); Shiori SUGIMOTO, Musashino-shi, Tokyo (JP); Takayuki KUROZUMI, Musashino-shi, Tokyo (JP); HIdeaki KIMATA, Musashino-shi, Tokyo (JP)

(73) Assignee: NIPPON TELEGRAPH AND TELEPHONE CORPORATION, Tokyo (JP)

(21) Appl. No.: 18/565,396

(22) PCT Filed: Jun. 30, 2021
(86) PCT No.: PCT/JP2021/024673

§ 371 Date: Nov. 29, 2023

(51) Int. Cl. G06V 10/94; G06V 10/70

(52) U.S. Cl. CPC G06V 10/94; G06V 10/70

(57) ABSTRACT

A learning device including: a learning data acquisition unit configured to acquire learning data including image data to be captured that has been captured through a filter and filter state information indicating a state of the filter; and a learning unit configured to execute a mathematical model including fidelity processing of generating a tensor in which a solution is a tensor closest to a tensor to be processed by solving an inverse problem, and regularization processing of generating image data of an image having a property close to a statistical property satisfied by an image to be captured, in which the number of tensors to be processed by the fidelity processing is larger than the number of tensors to be processed by the regularization processing, each tensor to be processed by the fidelity processing is smaller in size than a tensor to be processed by the regularization processing, the tensor to be processed by the regularization processing is a combination of the tensors generated by the fidelity processing, and the fidelity processing and the regularization processing are alternately executed.

### TECHNICAL FIELD

The present invention relates to a learning device, a learning method, and a program.

### BACKGROUND ART

In a case where there is not enough information regarding an image to be estimated, there is a technology for generating the original image by using an estimation result obtained by using Bayesian estimation. Compressed sensing is an example of such a technology.

### CITATION LIST

### Non Patent Literature

Non Patent Literature 1: Wagadarikar, Ashwin A., et al. “Video Rate Spectral Imaging Using a Coded Aperture Snapshot Spectral Imager.” Optics Express, vol. 17, no. 8, 2009, pp. 6368-6388.
Non Patent Literature 2: Lu Gan, “BLOCK COMPRESSED SENSING OF NATURAL IMAGES”, Proc. of the 2007 15th Intl. Conf. on Digital Signal Processing (DSP 2007), 403-406.
Non Patent Literature 3: Zhang, Jian, and Bernard Ghanem. “ISTA-Net: Interpretable Optimization-Inspired Deep Network for Image Compressive Sensing.” 2018 IEEE/CVF Conference on Computer Vision and Pattern Recognition (CVPR), 2018, pp. 1828-1837.
Non Patent Literature 4: Wang, Lizhi, et al. “Hyperspectral Image Reconstruction Using a Deep Spatial-Spectral Prior.” 2019 IEEE/CVF Conference on Computer Vision and Pattern Recognition (CVPR), 2019, pp. 8032-8041.

### SUMMARY OF INVENTION

### Technical Problem

However, in such a technology, there have been cases where the amount of computation increases in proportion to a power of input information (for example, Non Patent Literatures 3 and 4). Moreover, there have been cases where suppressing an increase in amount of computation results in a reduction in accuracy of generated images. That is, it has been difficult to achieve both suppression of an increase in amount of computation and the accuracy of the generated images. This has been a problem common not only to images but also to signals.

In view of the above circumstances, it is an object of the present invention to provide a technology that allows for both an increase in amount of computation required for signal generation and accuracy of the signal generation.

### Solution to Problem

One aspect of the present invention provides a learning device including: a learning data acquisition unit configured to acquire learning data including image data of an image to be captured that has been captured through a filter and filter state information indicating a state of the filter; and a learning unit configured to execute an image reconstruction model that is a mathematical model including: fidelity processing that is processing of generating, on the basis of the learning data, a tensor in which a solution is a tensor closest to a tensor to be processed by solving an inverse problem; and regularization processing that is processing of generating, on the basis of the learning data, image data of an image having a property close to a statistical property satisfied by the image to be captured, in which the number of tensors to be processed by the fidelity processing is larger than the number of tensors to be processed by the regularization processing, each tensor to be processed by the fidelity processing is smaller in size than a tensor to be processed by the regularization processing, the tensor to be processed by the regularization processing is a combination of the tensors generated by the fidelity processing, and the fidelity processing and the regularization processing are alternately executed.

One aspect of the present invention provides a learning device including: a learning data acquisition unit configured to acquire learning data including a signal obtained by imaging an imaging target through a filter and filter state information indicating a state of the filter; and a learning unit configured to execute an image reconstruction model that is a mathematical model including: fidelity processing that is processing of generating, on the basis of the learning data, a tensor in which a solution is a tensor closest to a tensor to be processed by solving an inverse problem; and regularization processing that is processing of generating, on the basis of the learning data, a signal having a property close to a statistical property satisfied by the signal obtained by imaging the imaging target, in which the number of tensors to be processed by the fidelity processing is larger than the number of tensors to be processed by the regularization processing, each tensor to be processed by the fidelity processing is smaller in size than a tensor to be processed by the regularization processing, the tensor to be processed by the regularization processing is a combination of the tensors generated by the fidelity processing, and the fidelity processing and the regularization processing are alternately executed.

One aspect of the present invention provides a learning method including: a learning data acquisition step of acquiring learning data including image data of an image to be captured that has been captured through a filter and filter state information indicating a state of the filter; and a learning step of executing an image reconstruction model that is a mathematical model including: fidelity processing that is processing of generating, on the basis of the learning data, a tensor in which a solution is a tensor closest to a tensor to be processed by solving an inverse problem; and regularization processing that is processing of generating, on the basis of the learning data, image data of an image having a property close to a statistical property satisfied by the image to be captured, in which the number of tensors to be processed by the fidelity processing is larger than the number of tensors to be processed by the regularization processing, each tensor to be processed by the fidelity processing is smaller in size than a tensor to be processed by the regularization processing, the tensor to be processed by the regularization processing is a combination of the tensors generated by the fidelity processing, and the fidelity processing and the regularization processing are alternately executed.

One aspect of the present invention is a program for causing a computer to function as the learning device.

### Advantageous Effects of Invention

The present invention allows for both an increase in amount of computation required for signal generation and accuracy of the signal generation.

### BRIEF DESCRIPTION OF DRAWINGS

FIG. 1 is an explanatory diagram illustrating an outline of an image generation system according to an embodiment.

FIG. 2 is an explanatory diagram illustrating a reconstruction neural network in the image generation system according to the embodiment.

FIG. 3 is a diagram illustrating an example of a hardware configuration of a control device according to the embodiment.

FIG. 4 is a diagram illustrating an example of a functional configuration of a control unit according to the embodiment.

FIG. 5 is a diagram illustrating an example of a flow of processing executed by the image generation system according to the embodiment.

FIG. 6 is a diagram illustrating an example of a hardware configuration of a learning device according to the embodiment.

FIG. 7 is a diagram illustrating an example of a functional configuration of a control unit according to the embodiment.

FIG. 8 is a flowchart illustrating an example of a flow of processing executed by the learning device according to the embodiment.

### DESCRIPTION OF EMBODIMENTS

### Embodiment

While the description below takes an image as an example, the following description is applicable in common to not only images but also signals in general.

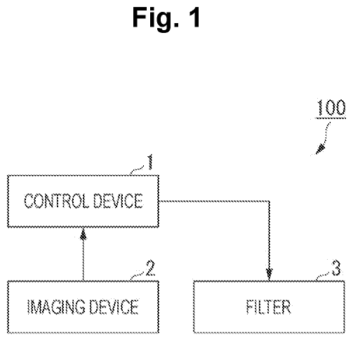

FIG. 1 is an explanatory diagram illustrating an outline of an image generation system 100 according to an embodiment. First, the outline of the image generation system 100 will be described. The image generation system 100 is a system that generates image data of an image to be captured. The image is, for example, a photograph. The image generation system 100 includes at least a control device 1, an imaging device 2, and a filter 3. The control device 1 controls the image generation system 100.

The imaging device 2 may be any sensor that uses one or a plurality of photodiodes. The sensor may be, for example, any camera or any X-ray camera. In a case where the imaging device 2 is an X-ray camera, the image generation system 100 may be used for X-ray imaging, for example. The imaging device 2 may be constituted by one photodiode, or may be a two-dimensional array of photodiodes. The imaging device 2 may include a photodiode for each of primary colors such as R, G, and B.

The imaging device 2 outputs information indicating a frequency and intensity of an incident electromagnetic wave (hereinafter referred to as “electromagnetic wave information”). The electromagnetic wave information is the frequency and the intensity in a case of a configuration constituted by one photodiode, and the electromagnetic wave information is information indicating a spatial distribution of the frequency and the intensity in a case of a configuration constituted by a two-dimensional array of photodiodes. Hereinafter, a case where the imaging device 2 is constituted by one photodiode will be described.

The filter 3 is a medium in which a spatial distribution of optical constants changes due to a predetermined action such as application of a voltage, application of a magnetic field, application of heat, or application of a load. The filter 3 is, for example, a thin film formed with the use of a photorefractive material. The filter 3 may be, for example, a photonic crystal in which a dielectric constant or structure changes by application of an action. The spatial distribution of optical constants of the filter 3 is controlled by the control device 1. The spatial distribution of optical constants may be, for example, a spatial distribution of the positions of openings (that is, an opening pattern).

The imaging device 2 images an imaging target through the filter 3. In a case where the imaging device 2 is constituted by one photodiode, the imaging device 2 converts a signal incident through the filter 3 into an electrical signal. The processing of converting an incident signal into an electrical signal is imaging. Therefore, the contents indicated by the electromagnetic wave information depend on the imaging target and the state of the filter 3. Specifically, the state of the filter 3 is the spatial distribution of optical constants of the filter 3.

In the image generation system 100, generation of electromagnetic wave information by the imaging device 2 and filter state change processing are repeatedly executed until a predetermined end condition is satisfied. The filter state change processing is processing of changing the state of the filter 3 on the basis of filter state information and electromagnetic wave information obtained before the predetermined end condition is satisfied. The filter state information is information indicating the spatial distribution of optical constants of the filter 3. Information obtained by solving an inverse problem on the basis of the electromagnetic wave information and the filter state information obtained before the time when the predetermined end condition (hereinafter referred to as a “filter state change end condition”) is satisfied is image data (hereinafter referred to as “final image data”) output to a predetermined output destination such as a storage device. That is, the inverse problem is solved with the use of one or a plurality of pieces of electromagnetic wave information. The filter state change processing is executed by the control device 1.

The filter state change end condition is, for example, a condition that the filter state change processing has been executed a predetermined number of times.

More specifically, the filter state change processing is processing of changing the state of the filter 3 in such a way that an object that satisfies a predetermined concealment condition is not captured. The concealment condition is a condition satisfied by a target object that should be prevented from information leakage due to imaging. Therefore, an image indicated by the final image data (hereinafter referred to as a “final image”) does not include the object that satisfies the concealment condition. The object that satisfies the concealment condition is, for example, a face. The filter state change processing may be processing the contents of which are determined by a machine learning method or may be processing the contents of which are determined in advance by a method other than machine learning.

The image generation system 100 generates image data in such a way that information regarding an object that meets the concealment condition is not further acquired after the time when it was determined that the object meets the concealment condition. In other words, image data is generated such that an object that satisfies the concealment condition has a smaller amount of information than an object that does not satisfy the concealment condition. That is, the image generation system 100 controls an optical system to generate image data in which the amount of information regarding an object that meets the concealment condition is smaller than the amount of information regarding an object that does not satisfy the concealment condition. The image generation system 100 is not configured to process obtained image to delete an object that satisfies the concealment condition from the image, and obtain, as a result of the deletion, image data in which the amount of information is smaller than that of an object that does not satisfy the concealment condition. Therefore, the image generation system 100 can prevent leakage of information due to imaging.

### <Filter State Change Processing>

The filter state change processing will be described. The filter state change processing includes image reconstruction processing and optimization processing. The image reconstruction processing is processing of solving an inverse problem on the basis of electromagnetic wave information and filter state information. The image reconstruction processing solves the inverse problem to estimate image data of an image to be captured. The image data estimated by the image reconstruction processing is hereinafter referred to as reconstructed image data. The image indicated by the reconstructed image data is hereinafter referred to as a reconstructed image. The present embodiment indicates that an image is reconstructed from a small number of samples by the image reconstruction processing. The small number of samples means, for example, some of pixels constituting an object. As described above, an image is reconstructed from a small amount of information, and this allows the image generation system 100 to estimate what is being captured even from an amount of information insufficient for estimating the object being captured.

Examples of the method for solving the inverse problem include compressed sensing. The method for solving the inverse problem may be, for example, a convex optimization method such as a method in which a total variation minimization is used as a regularization term and the problem is solved by an alternating direction method of multiplier (ADMM). The method for solving the inverse problem may be, for example, a method using a learned model obtained using deep learning.

The optimization processing is processing of changing the state of the filter 3 in such a way that an object that satisfies a predetermined concealment condition is not captured on the basis of a reconstructed image data. Therefore, the optimization processing is processing of controlling the spatial distribution of optical constants of the filter 3 on the basis of the reconstructed image data. Therefore, the optimization processing is, for example, processing of controlling the opening pattern of the filter 3 on the basis of the reconstructed image data.

### <Optimization Processing>

The optimization processing will be described more specifically. The optimization processing includes filter state information update processing and update information application processing. The filter state information update processing is processing of updating filter state information on the basis of a reconstructed image. The updated filter state information indicates the state of the filter 3 so that an update condition is satisfied. The update condition is a condition that the state of the filter 3 indicated by the filter state information after update obtained by the filter state information update processing is a state in which an object that satisfies a predetermined concealment condition is less captured as compared with before the update.

In the filter state information update processing, the filter state information may be updated by any method as long as the filter state information can be updated so that the update condition is satisfied on the basis of the reconstructed image.

The update information application processing is processing of controlling the state of the filter 3 so that the state of the filter 3 is the state indicated by the filter state information after update that has been updated by the filter state information update processing.

### <First Example of Processing of Updating Filter State Information>

In the filter state information update processing, the filter state information may be updated by execution of, for example, random number update processing, detection processing, and mask processing.

The random number update processing is processing of updating the filter state information by using a random number of a Gaussian distribution. The random number update processing updates the spatial distribution of optical constants of the filter 3 indicated by the filter state information. The detection processing is processing of detecting an object that satisfies the concealment condition on the basis of the reconstructed image. The detection of an object that satisfies the concealment condition may be, for example, processing of detecting an object that satisfies the concealment condition by detecting a feature of the object that satisfies the concealment condition. In a case where the object that satisfies the concealment condition is, for example, a face, the feature of the object that satisfies the concealment condition is, for example, eyes, a nose, or a mouth.

The mask processing is processing of updating some of the optical constants at the individual positions in the filter 3 indicated by the filter state information that has been updated by the random number update processing. The mask processing updates the optical constant at a position, among the individual positions in the filter 3, corresponding to an object detected by the detection processing. Specifically, the corresponding position is a position on the filter 3 through which an electromagnetic wave coming from an imaging target and incident on the imaging device 2 passes in an optical system formed by the imaging target, the filter 3, and the imaging device 2. In the mask processing, the optical constant to be updated is changed to a value that reduces transmittance of the electromagnetic wave coming from the imaging target in the optical system formed by the imaging target, the filter 3, and the imaging device 2.

In this manner, the filter state information is updated so as to satisfy the update condition by execution of the random number update processing, the detection processing, and the mask processing.

### <Second Example of Processing of Updating Filter State Information>

The filter state information update processing may be, for example, processing of updating the filter state information on the basis of the reconstructed image data by using a learned model obtained by performing learning so as to satisfy filter loss conditions described below by a machine learning method (hereinafter, the processing is referred to as “machine learning processing”). In the learning performed so as to satisfy the filter loss conditions, a large amount of image data is prepared as simulation image data to be captured. The learning uses the image data to be captured (hereinafter referred to as “first learning data”) and reconstructed image data (hereinafter referred to as “second learning data”) obtained through the image reconstruction processing when the image data to be captured is input.

The filter loss conditions include a first entire image condition and a local image difference increase condition. The first entire image condition is a condition that a difference between an image indicated by the first learning data and an image indicated by the second learning data is reduced. The local image difference increase condition is a condition that a difference between an object that satisfies the concealment condition in the image to be captured and the object that satisfies the concealment condition in the reconstructed image data is increased. As described above, in the learning, processing of accurately acquiring the entire image to be captured while not acquiring detailed information regarding the object that satisfies the concealment condition in the image to be captured is executed. That is, in learning, in order not to capture an object that satisfies a predetermined concealment condition in the image to be captured, the filter state information is updated so as to satisfy a condition that a difference between an imaging target object and a reconstructed image is increased for the object that satisfies the concealment condition. The machine learning method is, for example, deep learning.

In this manner, the filter state information is updated so as to satisfy the update condition by execution of the machine learning processing.

### <Adversarial Learning>

Meanwhile, the image reconstruction processing may be processing using a learned model obtained by the machine learning method as described above, and the filter state information update processing may also be processing using a learned model obtained by the machine learning method as described above. Thus, acquisition of the learned model used in the image reconstruction processing and acquisition of the learned model used in the filter state information update processing may be or may not be performed independently of each other. “May not be performed independently of each other” specifically means that the learned models may be obtained by adversarial learning.

For the sake of simplicity of description, a mathematical model before a predetermined end condition regarding the end of learning is satisfied, the mathematical model being for estimating reconstructed image data on the basis of electromagnetic wave information and filter state information, is hereinafter referred to as an image reconstruction model. The image reconstruction model at the time when the predetermined end condition regarding the end of learning is satisfied is a learned image reconstruction model, and the learned image reconstruction model is a learned model used in the image reconstruction processing.

For the sake of simplicity of description, a mathematical model before the predetermined end condition regarding the end of learning is satisfied, the mathematical model being for updating the filter state information on the basis of the reconstructed image data, is hereinafter referred to as a filter state information update model. The filter state information update model at the time when the predetermined end condition regarding the end of learning is satisfied is a learned filter state information update model, and the learned filter state information update model is a learned model used in the filter state information update processing. The machine learning processing described above can also be said to be processing of executing the filter state information update model.

A method in which an image reconstruction model obtains, by adversarial learning, a learned model used in the image reconstruction processing and a learned model used in the filter state information update processing will be specifically described. In the adversarial learning, the image reconstruction model and the filter state information update model are alternately updated according to a predetermined rule. The filter state information update model is updated so that the filter loss conditions described above are satisfied. The image reconstruction model is updated so that reconstruction loss conditions are satisfied. Learning data used for updating (that is, learning) the image reconstruction model includes electromagnetic wave information and filter state information.

The reconstruction loss conditions include a second entire image condition and a local image difference reduction condition. The second entire image condition is a condition that a difference between the image indicated by the first learning data and the entire reconstructed image (that is, the entire image indicated by the second learning data) obtained on the basis of the electromagnetic wave information and the filter state information is reduced. The local image difference reduction condition is a condition that a difference between an object that satisfies the concealment condition in the image to be captured and the object that satisfies the concealment condition in the reconstructed image data is reduced.

As described above, in the adversarial learning, for the filter state information update model, learning is performed so that the difference between an object that satisfies the concealment condition in the image obtained as a result of the processing and the object that satisfies the concealment condition in the image to be captured is increased. On the other hand, for the image reconstruction model, learning is performed so that the difference between an object that satisfies the concealment condition in the image obtained as a result of the processing and the object that satisfies the concealment condition in the image to be captured is reduced. Therefore, learning of the filter state information update model and learning of the image reconstruction model are adversarial learning.

### <Example of Image Reconstruction Model>

Here, a more specific example of the image reconstruction model will be described. While it has been described that a reconstructed image may be obtained by compressed sensing, the convex optimization method is one of the methods for obtaining a solution by compressed sensing. That is, compressed sensing comes down to a convex optimization problem. The convex optimization method is a method of representing a mathematical expression to be solved by a sum of two terms, a fidelity term and a regularization term, with the use of an auxiliary variable, and optimizing fidelity terms and regularization terms in an alternating manner. That is, the convex optimization method is a method of solving fidelity terms and regularization terms in a self-consistent manner.

The image reconstruction model is expressed by, for example, a neural network that reflects this convex optimization method in machine learning. More specifically, the image reconstruction model is expressed by a neural network including a plurality of fidelity neural networks and a plurality of regularization neural networks. The fidelity neural networks express processing represented by the fidelity terms. The regularization neural networks express processing represented by the regularization terms. Hereinafter, a neural network that expresses an image reconstruction model is referred to as an image reconstruction neural network.

The neural network is a mathematical model in which contents of processing are updated by learning. The mathematical model is a set of one or a plurality of pieces of processing for which the timing of execution has been determined in advance. Therefore, executing the mathematical model means executing each piece of processing included in the mathematical model according to a predetermined rule.

In learning of the image reconstruction model, each of the fidelity neural networks and each of the regularization neural networks included in the image reconstruction neural network are updated by learning. This means that the contents of the processing of calculating the solutions of the fidelity terms and the regularization terms in a self-consistent manner, such as how a parameter changes in the processing of calculating the solutions of the fidelity terms and the regularization terms in a self-consistent manner, are updated by learning.

Meanwhile, as described above, the fidelity terms and the regularization terms are mathematically one and the other of two obtained by dividing the mathematical expression to be solved into two with the use of an auxiliary variable. However, the fidelity terms do not simply mean one of the two terms obtained by mathematical division into two, but are terms defined so that processing of optimizing the fidelity terms can be interpreted as processing of obtaining a value that minimizes a difference from a predetermined reference. The regularization terms are defined so that processing of optimizing the regularization terms can be interpreted as processing of obtaining a value that minimizes a difference from the amount indicated by prior information.

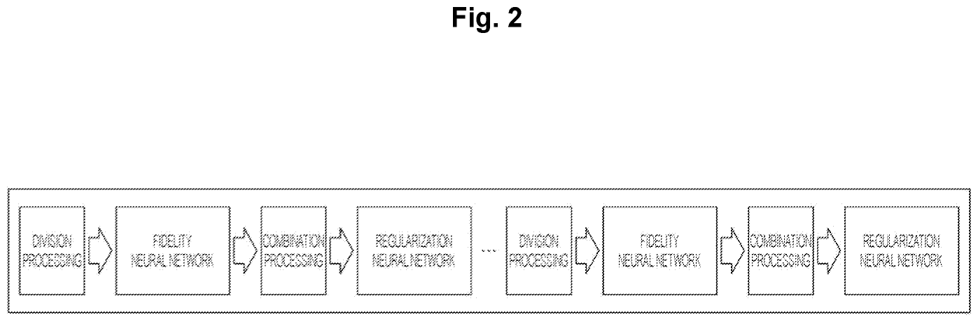

In the image generation system 100, fidelity neural networks are used instead of the fidelity terms, regularization neural networks are used instead of the regularization terms, and each of the fidelity neural networks and the regularization neural networks is given a definition that allows for physical interpretation. This will be described below with reference to FIG. 2.

FIG. 2 is an explanatory diagram illustrating a reconstruction neural network in the image generation system 100 according to the embodiment. The reconstruction neural network of the image generation system 100 includes fidelity neural networks and regularization neural networks in an alternating manner. That is, the fidelity processing and the regularization processing are alternately executed.

In the image generation system 100, image data expressed by a first- or higher-order tensor that has been divided into a plurality of smaller tensors is input to a fidelity neural network. Hereinafter, the plurality of smaller tensors is referred to as block tensors. A block is a submatrix in a case where the image data before being divided is expressed by a matrix. Division processing in FIG. 2 is processing of dividing image data expressed by a first- or higher-order tensor to be processed into a plurality of block tensors. In the division processing, information indicating arrangement of block tensors with respect to each other (hereinafter referred to as “block tensor arrangement information”) is also generated.

In the fidelity neural network, processing of outputting a tensor (hereinafter referred to as a “first provisional optimization block tensor”) that minimizes a difference from a predetermined reference is executed for each input block tensor (hereinafter, the processing is referred to as “fidelity processing”). Therefore, the fidelity neural network outputs the same number of first provisional optimization block tensors as the input block tensors. In the fidelity processing, the filter state information is also used.

The fidelity processing is processing that is expressed by the fidelity neural network and is represented by the fidelity term. The predetermined reference in the fidelity processing is the input block tensor itself. In general, in a case where a result of estimation based on input information is used to estimate the information on which the estimation has been based, it is not always possible to obtain the information on which the estimation has been based.

In the fidelity processing, a result obtained from an input block tensor is used to estimate the input block tensor, and a result of the estimation is compared with the input block tensor. In the fidelity processing, an image that minimizes the comparison result is output as a first provisional optimization block tensor. That is, the fidelity processing outputs, as a first provisional optimization block tensor, a tensor in which the solution is a tensor closest to the block tensor that has been input when an inverse problem is solved.

In the image generation system 100, a regularization neural network receives an input of a plurality of first provisional optimization block tensors that have been output from the fidelity neural network in the preceding stage and are in a combined state. The processing described as combination processing in FIG. 2 is processing of combining a plurality of first provisional optimization block tensors.

In the combination processing, combination is performed in a state in which optimization block tensors corresponding to the block tensors are arranged in the arrangement of the block tensors indicated by the block tensor arrangement information. A tensor generated by the combination processing is hereinafter referred to as a combined tensor. A combined tensor is constituted by a combination of block tensors, and the size of the combined tensor is larger than the size of each block tensor.

The regularization neural network executes, on a combined tensor that has been input, processing of outputting a tensor (hereinafter referred to as a “second provisional optimization block tensor”) that minimizes a difference from an amount indicated by predetermined prior information (hereinafter, the processing is referred to as “regularization processing”). The regularization processing is processing that is expressed by the regularization neural network and is represented by the regularization term.

The amount indicated by the predetermined prior information is a reference updated by learning. Specifically, the amount indicated by the prior information is an amount indicating a statistical property of each pixel of the image to be captured. The statistical property is, for example, a property in which many coefficients become 0 when a discrete cosine transform is performed. The property in which many coefficients become 0 when a discrete cosine transform is performed is called sparsity. An image having a smaller difference from the amount indicated by the prior information is closer to the image to be captured. As described above, the regularization processing is processing of generating image data (that is, a second provisional optimization block tensor) of an image having a property close to the statistical property satisfied by the image to be captured.

The following Formula (1) is an example of a mathematical expression expressing the fidelity processing, and Formula (2) is an example of a mathematical expression expressing the regularization processing.

$$\begin{matrix}[ Math . 1 ] & \\ {h}^{( k )} ← {arg min}_{h} {‖ h - ( {f}^{( k - 1 )} - {u}^{( k - 1 )} ) ‖}_{2}^{2} + \frac{τ}{η} R ( h ) = ℍ ( {f}^{( k - 1 )} - {u}^{( k - 1 )} ) & ( 1 )\end{matrix}$$

$$\begin{matrix}[ Math . 2 ] & \\ {f}^{( k )} ← {arg min}_{f} {‖ Φ f - g ‖}_{2}^{2} + η {‖ f - ( {h}^{k} + {u}^{( k - 1 )} ) ‖}_{2}^{2} = [ ( 1 - {ϵ}^{( k )} {η}^{( k )} ) I - {ϵ}^{( k )} {Φ}^{T} Φ ] {f}^{( k - 1 )} + {ϵ}^{( k )} {Φ}^{T} g + {ϵ}^{( k )} {η}^{( k )} ( {h}^{( k )} + {u}^{( k - 1 )} ) & ( 2 )\end{matrix}$$

In Formulas (1) and (2), f is a vector indicating image data of an image to be captured. When an index k is used, f and h represent provisional reconstructed image data of the image to be captured in a k-th iterative calculation. In Formulas (1) and (2), u represents an auxiliary variable. k is the number of repetitions of self-consistent processing. f is a vector indicating the image data of the image to be captured. g represents electromagnetic wave information. Φ is a tensor indicating filter state information. ε represents a step size in a gradient method. η represents a weight of a penalty term. τ represents a weight parameter. I represents an identity matrix. R represents a regularization term. A function H is a function that receives f and u as inputs.

As described above, in the fidelity processing, a result obtained from an input block tensor is used to estimate the input block tensor, and a result of the estimation is compared with the input block tensor. In the fidelity processing, as a result of the comparison, a tensor in which the solution is a tensor closest to the block tensor that has been input is output as a first provisional optimization block tensor. Therefore, the fidelity processing executes processing of obtaining a result by using the filter state information on the basis of the block tensor that has been input and processing of estimating the block tensor that has been input by solving an inverse problem by using the filter state information from the obtained result. More specifically, the filter state information used in solving the inverse problem is an inverse image of a mapping Φ that expresses the filter state information. Since elements are real numbers in the mapping that expresses the filter state information, the inverse image is a matrix proportional to a transposed matrix of the mapping Φ. Therefore, the fidelity processing, in which processing of estimating the input tensor by using a result obtained by using the filter state information from the input tensor is executed, requires the amount of computation for a power of the size of the tensor that expresses the mapping Φ.

That is, in the fidelity processing, consistency between provisional reconstructed image data (h^{(k)}) of an input k-th image to be captured and observed electromagnetic wave distribution information g is evaluated, and the provisional reconstructed image data of the input k-th image to be captured is converted so as to be consistent with the observed electromagnetic wave distribution information and is output. When this problem is solved with the use of the gradient method with the step size being ε, a matrix product of the transposed matrix of the mapping Φ that expresses the filter state information and the mapping Φ that expresses the filter state information is required. Therefore, the fidelity processing requires the amount of computation for a power of the size of the tensor that expresses the mapping Φ.

The fidelity processing uses, for Φ that indicates the filter state information, the matrix product of Φ and the transposed matrix of Φ as indicated by the first term of Formula (1). On the other hand, in the regularization processing, processing of convolving the input tensor with K filters is executed as indicated by the function H. That is, in the regularization processing, the amount of computation does not increase in accordance with the power, unlike the fidelity processing.

### <Effects Obtained by Division Processing and Combination Processing>

As described above, in the fidelity processing, the processing is executed for each block tensor. In the computation for each block tensor, it is only required to use, as the size of Φ, the same size as the size of the block tensor to be computed. This is because the product of Φ^{T}Φ belonging to R^{(L2×L2)} and f belonging to R^{(L2×1)} is divided into Φ′^{T}Φ′ belonging to R^{(12×12)} and f′ belonging to R^{(12×1)}. Where Φ is the filter state information and can have a structure that can be divided. Being able to be divided means that the same result is obtained also in a case where the product of Φ and the block tensor is computed after division. In a case where division processing is not executed, the fidelity processing requires a computation that is the fourth power of N in accordance with size N of the input tensor, but in a case where p block tensors of size M are generated by division processing, the amount of computation required is p times the fourth power of M. The input tensor is a tensor to be processed. Non Patent Literature 1 and Non Patent Literature 2 are examples of Φ having a structure that can be divided.

As described above, in the regularization processing, the combination processing is executed. In the regularization processing, it is important to generate an image in which the entire image is close to the entire image to be captured. Therefore, not only the property of each of the block tensors but also information regarding the arrangement of the block tensors with respect to each other is important. Thus, unlike the case of the fidelity processing, the tensor obtained by the combination processing is used in the regularization processing. In the regularization processing, the amount of computation does not increase in accordance with the power as described above, unlike the fidelity processing. Therefore, it is better to use the tensor obtained by the combination processing than to use the block tensors.

As described above, the image reconstruction model executes the fidelity processing, which is processing of performing a computation proportional to the power of the tensor to be processed and is processing of generating, on the basis of learning data, a tensor in which the solution is a tensor closest to the tensor to be processed when the inverse problem is solved. Furthermore, the image reconstruction model executes the regularization processing, which is processing of performing a computation proportional to the tensor to be processed and is processing of generating image data of an image having a property close to the statistical property satisfied by the image to be captured on the basis of learning data.

In addition, a combination of block tensors being a combined tensor means the following. That is, the number of tensors to be processed by the fidelity processing is larger than the number of tensors to be processed by the regularization processing, and each tensor to be processed by the fidelity processing is smaller in size than a tensor to be processed by the regularization processing.

In the learning of the image reconstruction model, the fidelity neural network is updated such that the tensor to be generated is closer to the tensor to be processed when the inverse problem is solved. In the learning of the image reconstruction model, the regularization neural network is updated such that the tensor to be generated generates image data of an image having a property closer to the statistical property satisfied by the image to be captured.

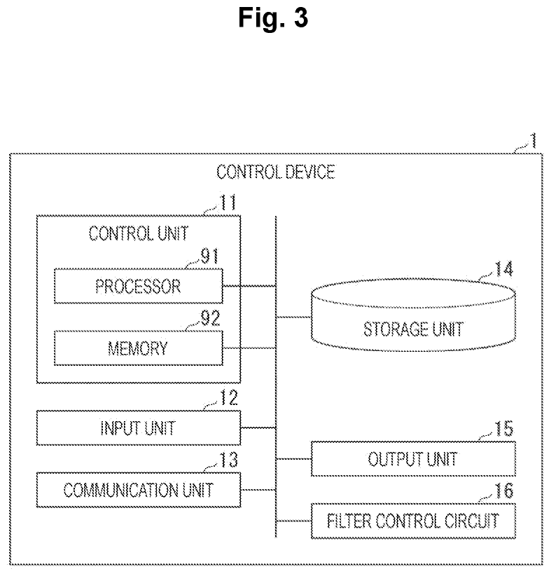

FIG. 3 is a diagram illustrating an example of a hardware configuration of the control device 1 according to the embodiment. The control device 1 includes a control unit 11 including a processor 91 such as a central processing unit (CPU) and a memory 92, which are connected by a bus, and executes a program. The control device 1 functions as a device including the control unit 11, an input unit 12, a communication unit 13, a storage unit 14, an output unit 15, and a filter control circuit 16 by executing the program.

More specifically, the processor 91 reads the program stored in the storage unit 14, and stores the read program in the memory 92. The processor 91 executes the program stored in the memory 92 to cause the control device 1 to function as a device including the control unit 11, the input unit 12, the communication unit 13, the storage unit 14, the output unit 15, and the filter control circuit 16.

The control unit 11 controls operations of various functional units included in the control device 1. The control unit 11 executes, for example, the filter state change processing. The control unit 11 controls the state of the filter 3 by, for example, controlling the operation of the filter control circuit 16. The control unit 11 records, for example, various types of information generated by execution of the filter state change processing in the storage unit 14.

The input unit 12 includes an input device such as a mouse, a keyboard, and a touch panel. The input unit 12 may be configured as an interface that connects such an input device to the control device 1. The input unit 12 receives inputs of various types of information to the control device 1.

The communication unit 13 includes a communication interface for connecting the control device 1 to an external device. The communication unit 13 communicates with the external device in a wired or wireless manner. The external device is, for example, the imaging device 2. The communication unit 13 acquires electromagnetic wave information by communication with the imaging device 2.

The storage unit 14 is configured using a non-transitory computer-readable storage medium device such as a magnetic hard disk device or a semiconductor storage device. The storage unit 14 stores various types of information regarding the control device 1. The storage unit 14 stores, for example, information input via the input unit 12 or the communication unit 13. The storage unit 14 stores, for example, various types of information generated by execution of the filter state change processing. The storage unit 14 stores, for example, the filter state information.

The output unit 15 outputs various types of information. The output unit 15 includes, for example, a display device such as a cathode ray tube (CRT) display, a liquid crystal display, or an organic electro-luminescence (EL) display. The output unit 15 may be configured as an interface that connects such a display device to the control device 1. The output unit 15 outputs, for example, information input to the input unit 12. The output unit 15 outputs, for example, final image data.

The filter control circuit 16 is a circuit that gives the filter 3 an action that changes the state of the filter 3. The filter control circuit 16 is, for example, a circuit that applies a voltage to the filter 3.

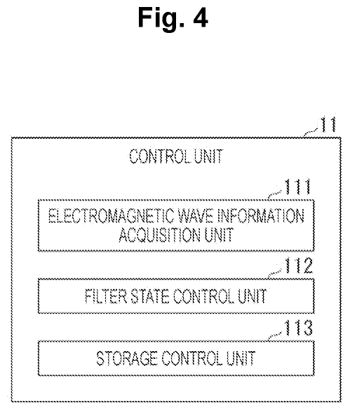

FIG. 4 is a diagram illustrating an example of a functional configuration of the control unit 11 according to the embodiment. The control unit 11 includes an electromagnetic wave information acquisition unit 111, a filter state control unit 112, and a storage control unit 113. The electromagnetic wave information acquisition unit 111 acquires electromagnetic wave information generated by the imaging device 2. The filter state control unit 112 executes the filter state change processing and end determination processing.

The end determination processing is processing of determining whether a filter state change end condition is satisfied. The storage control unit 113 records various types of information in the storage unit 14. For example, every time the filter state control unit 112 changes the state of the filter 3, the storage control unit 113 records, in the storage unit 14, filter state information indicating the state of the filter 3 generated as a result of the control.

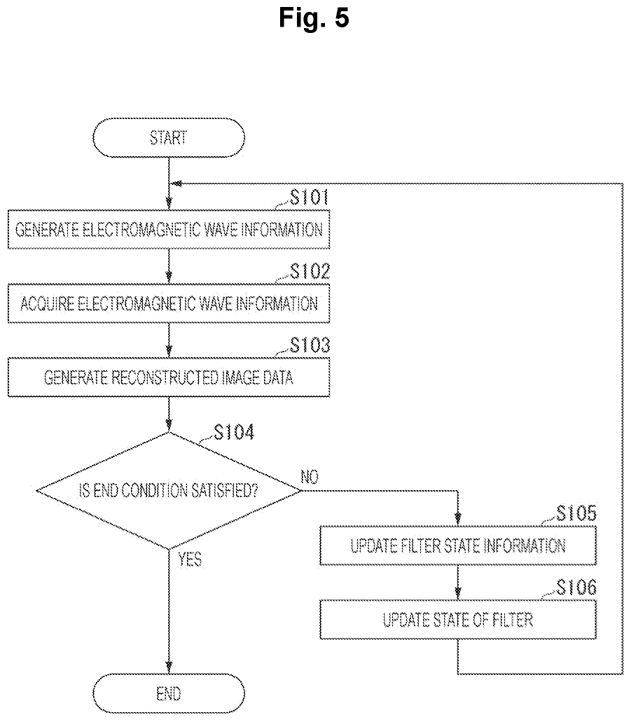

FIG. 5 is a diagram illustrating an example of a flow of processing executed by the image generation system 100 according to the embodiment. The imaging device 2 generates electromagnetic wave information (step S101). Next, the electromagnetic wave information acquisition unit 111 acquires the electromagnetic wave information generated in step S101 via the communication unit 13 (step S102). Next, the filter state control unit 112 executes image reconstruction processing (step S103). Reconstructed image data is generated by execution of the image reconstruction processing.

The filter state control unit 112 executes end determination processing (step S104). If the filter state change end condition is satisfied (step S104: YES), the processing ends. The reconstructed image data at the end of the processing is final image data.

On the other hand, if the filter state change end condition is not satisfied (step S104: NO), the filter state control unit 112 executes filter state information update processing (step S105). More specifically, the filter state control unit 112 updates the filter state information on the basis of the filter state information stored in the storage unit 14 and the reconstructed image data acquired in step S103.

Next, the filter state control unit 112 executes update information application processing (step S106). By executing the update information application processing, the filter state control unit 112 controls the operation of the filter control circuit 16 to control the state of the filter 3 such that the state of the filter 3 is the state indicated by the updated filter state information that has been updated by the filter state information update processing. Next, the processing returns to step S101.

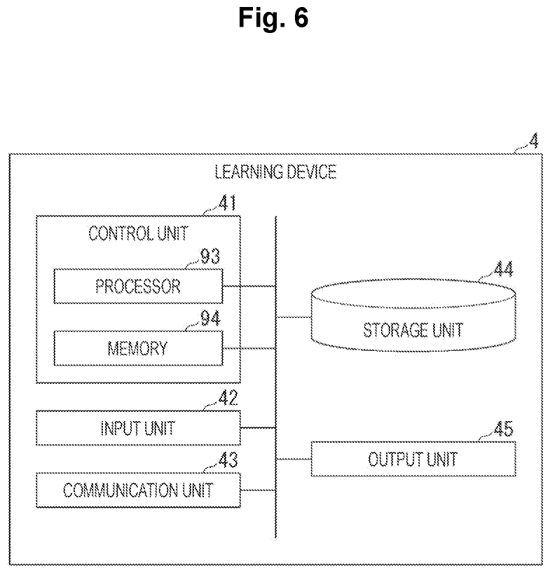

An image reconstruction model is generated by a learning device 4 illustrated in FIG. 6 below, for example. FIG. 6 is a diagram illustrating an example of a hardware configuration of the learning device 4 according to the embodiment. The learning device 4 includes a control unit 41 including a processor 93 such as a CPU and a memory 94 connected via a bus, and executes a program. The learning device 4 functions as a device including the control unit 41, an input unit 42, a communication unit 43, a storage unit 44, and an output unit 45 by executing the program.

More specifically, the processor 93 reads the program stored in the storage unit 44, and stores the read program in the memory 94. The processor 93 executes the program stored in the memory 94 to cause the learning device 4 to function as a device including the control unit 41, the input unit 42, the communication unit 43, the storage unit 44, and the output unit 45.

The control unit 41 controls operations of various functional units included in the learning device 4. The control unit 41 executes, for example, image reconstruction model learning processing. The image reconstruction model learning processing is processing of updating the image reconstruction model on the basis of the electromagnetic wave information and the filter state information until a predetermined end condition (hereinafter referred to as a “learning end condition”) is satisfied.

The learning end condition is, for example, a condition that learning has been performed a predetermined number of times. The learning end condition may be, for example, a condition that a change in the image reconstruction model by learning is smaller than a predetermined change. The image reconstruction model at the time when the learning end condition is satisfied is a learned image reconstruction model.

The control unit 41 records, for example, various types of information generated by execution of the image reconstruction model learning processing in the storage unit 44.

The input unit 42 includes an input device such as a mouse, a keyboard, or a touch panel. The input unit 42 may be configured as an interface that connects such an input device to the learning device 4. The input unit 42 receives inputs of various types of information to the learning device 4. For example, a combination of electromagnetic wave information and filter state information is input to the input unit 42 as learning data to be used in the image reconstruction model learning processing.

The communication unit 43 includes a communication interface for connecting the learning device 4 to an external device. The communication unit 43 communicates with an external device in a wired or wireless manner.

The storage unit 44 is configured using a non-transitory computer-readable storage medium device such as a magnetic hard disk device or a semiconductor storage device. The storage unit 44 stores various types of information regarding the learning device 4. The storage unit 44 stores, for example, information input via the input unit 42 or the communication unit 43. The storage unit 44 stores, for example, various types of information generated by execution of the image reconstruction model learning processing. The storage unit 44 stores, for example, a combination of electromagnetic wave information and filter state information as learning data. The storage unit 44 stores an image reconstruction model to be updated in advance.

The output unit 45 outputs various types of information. The output unit 45 includes, for example, a display device such as a CRT display, a liquid crystal display, or an organic EL display. The output unit 45 may be configured as an interface that connects such a display device to the learning device 4. The output unit 45 outputs, for example, information input to the input unit 42.

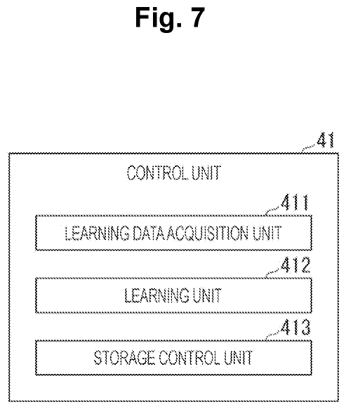

FIG. 7 is a diagram illustrating an example of a functional configuration of the control unit 41 according to the embodiment. The control unit 41 includes a learning data acquisition unit 411, a learning unit 412, and a storage control unit 413. The learning data acquisition unit 411 acquires a combination of electromagnetic wave information and filter state information as learning data.

The learning unit 412 executes image reconstruction model learning processing. By executing the image reconstruction model learning processing, the learning unit 412 performs learning of an image reconstruction model on the basis of the learning data acquired by the learning data acquisition unit 411. At the time of learning, an image reconstruction model to be updated is executed, and the image reconstruction model is updated on the basis of a result of execution of the image reconstruction model. An image reconstruction model includes fidelity processing and regularization processing, and execution of the image reconstruction model also means execution of the fidelity processing and the regularization processing.

The storage control unit 413 records various types of information in the storage unit 44.

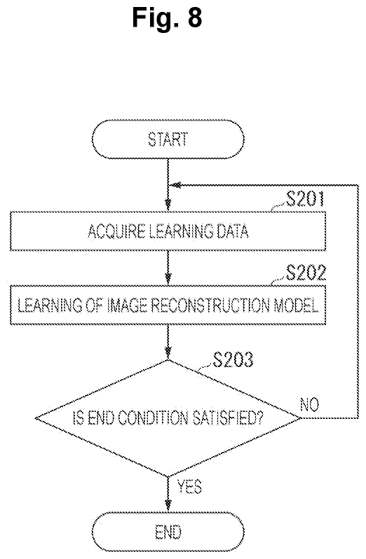

FIG. 8 is a flowchart illustrating an example of a flow of processing executed by the learning device 4 according to the embodiment. The learning data acquisition unit 411 acquires a combination of electromagnetic wave information and filter state information as learning data (step S201). Next, the learning unit 412 updates an image reconstruction model on the basis of the learning data acquired in step S201 (step S202). Next, the learning unit 412 determines whether a learning end condition is satisfied (step S203). If the learning end condition is satisfied (step S203: YES), the processing ends. On the other hand, if the learning end condition is not satisfied (step S203: NO), the processing returns to step S201.

The control device 1 according to the embodiment configured as described above controls the filter 3 to generate image data of an image that does not include any object that satisfies the concealment condition. That is, the control device 1 controls the optical system to generate image data of an image that does not include any object that satisfies the concealment condition. The control device 1 is not configured to process an obtained image to delete an object that satisfies the concealment condition from the image, and obtain, as a result of the deletion, an image that does not include the object that satisfies the concealment condition. Therefore, the control device 1 can prevent leakage of information due to imaging.

The learning device 4 according to the embodiment configured as described above executes fidelity processing and regularization processing. The fidelity processing is processing of performing a computation proportional to the power of a tensor that has been input, and is processing of generating a tensor in which the solution is a tensor closest to the tensor that has been input when an inverse problem is solved.

The regularization processing is processing of performing a computation proportional to a tensor that has been input, and is processing of generating image data of an image having a property close to the statistical property satisfied by the image to be captured. Then, the fidelity processing process block tensors, and the regularization processing process a combined tensor. Thus, the learning device 4 allows for both an increase in amount of computation required for image generation and accuracy of the image generation.

### Modification Examples

The image reconstruction model learning processing may be executed by the control device 1. That is, the control unit 11 may include the learning data acquisition unit 411 and the learning unit 412.

The fidelity neural networks and the regularization neural networks may be the neural network described in Reference Literature 1 below, except for a difference in input data.
Reference Literature 1: Yoko Sogabe, Shiori Sugimoto, Takayuki Kurozumi, and Hideaki Kimata “ADMM-INSPIRED RECONSTRUCTION NETWORK FOR COMPRESSIVE SPECTRAL IMAGING” ICIP 2020, 2865-2869

The control device 1 may be implemented by using a plurality of information processing devices communicably connected to each other via a network. In this case, the functional units included in the control device 1 may be implemented in a distributed manner in the plurality of information processing devices.

The learning device 4 may be implemented by using a plurality of information processing devices communicably connected to each other via a network. In this case, the functional units included in the learning device 4 may be implemented in a distributed manner in the plurality of information processing devices.

The control device 1 is an example of an image generation device. The electromagnetic wave information is an example of image data of an image to be captured that has been captured through the filter 3. In a case where the control device 1 and the learning device 4 are configured to process a signal instead of an image, the control device 1 and the learning device 4 use a signal obtained by imaging an imaging target through the filter 3, instead of the electromagnetic wave information. In such a case, the regularization processing generates a signal having a property close to the statistical property satisfied by the signal obtained by imaging the imaging target, instead of image data of an image having a property close to the statistical property satisfied by the image to be captured. The filter 3 is an example of an acquisition unit. The imaging device 2 is an example of a conversion unit. The signal transmitted through the filter 3, that is, the signal incident on the imaging device 2, is an example of an observation signal. The electrical signal output from the photodiode is an example of a partial image signal. The object that satisfies a predetermined concealment condition is an example of a subject that belongs to a predetermined attribute. The image to be captured is an example of an area constituting an image.

Note that all or some of the functions of the control device 1 and the learning device 4 may be implemented by using hardware such as an application specific integrated circuit (ASIC), a programmable logic device (PLD), or a field programmable gate array (FPGA). The program may be recorded on a computer-readable recording medium. The “computer-readable recording medium” refers to, for example, a portable medium such as a flexible disk, a magneto-optical disc, a ROM, or a CD-ROM, or a storage device such as a hard disk built in a computer system. The program may be transmitted via an electrical communication line.

Although the embodiment of the present invention has been described in detail with reference to the drawings, specific configurations are not limited to the embodiment and include design and the like without departing from the gist of the present invention.

### REFERENCE SIGNS LIST

100 Image generation system
1 Control device
2 Imaging device
3 Filter
4 Learning device
11 Control unit
12 Input unit
13 Communication unit
14 Storage unit
15 Output unit
16 Filter control circuit
111 Electromagnetic wave information acquisition unit
112 Filter state control unit
113 Storage control unit
41 Control unit
42 Input unit
43 Communication unit
44 Storage unit
45 Output unit
411 Learning data acquisition unit
412 Learning unit
413 Storage control unit
91 Processor
92 Memory
93 Processor
94 Memory

1. A learning device comprising:
a processor; and
a storage medium having computer program instructions stored thereon, when executed by the processor, perform to:
acquire learning data including image data of an image to be captured that has been captured through a filter and filter state information indicating a state of the filter; and
execute an image reconstruction model that is a mathematical model including: fidelity processing that is processing of generating, on the basis of the learning data, a tensor in which a solution is a tensor closest to a tensor to be processed by solving an inverse problem; and regularization processing that is processing of generating, on the basis of the learning data, image data of an image having a property close to a statistical property satisfied by the image to be captured,
wherein the number of tensors to be processed by the fidelity processing is larger than the number of tensors to be processed by the regularization processing, each tensor to be processed by the fidelity processing is smaller in size than a tensor to be processed by the regularization processing, and the tensor to be processed by the regularization processing is a combination of the tensors generated by the fidelity processing, and
the fidelity processing and the regularization processing are alternately executed.

2. The learning device according to claim 1,
wherein the state of the filter is a spatial distribution of optical constants of the filter.

3. A learning device comprising:
a processor; and
a storage medium having computer program instructions stored thereon, when executed by the processor, perform to:
acquire learning data including a signal obtained by imaging an imaging target through a filter and filter state information indicating a state of the filter; and
execute an image reconstruction model that is a mathematical model including: fidelity processing that is processing of generating, on the basis of the learning data, a tensor in which a solution is a tensor closest to a tensor to be processed by solving an inverse problem; and regularization processing that is processing of generating, on the basis of the learning data, a signal having a property close to a statistical property satisfied by the signal obtained by imaging the imaging target,
wherein the number of tensors to be processed by the fidelity processing is larger than the number of tensors to be processed by the regularization processing, each tensor to be processed by the fidelity processing is smaller in size than a tensor to be processed by the regularization processing, and the tensor to be processed by the regularization processing is a combination of the tensors generated by the fidelity processing, and
the fidelity processing and the regularization processing are alternately executed.

4. A learning method comprising:
a learning data acquisition step of acquiring learning data including image data of an image to be captured that has been captured through a filter and filter state information indicating a state of the filter; and
a learning step of executing an image reconstruction model that is a mathematical model including: fidelity processing that is processing of generating, on the basis of the learning data, a tensor in which a solution is a tensor closest to a tensor to be processed by solving an inverse problem; and regularization processing that is processing of generating, on the basis of the learning data, image data of an image having a property close to a statistical property satisfied by the image to be captured,
wherein the number of tensors to be processed by the fidelity processing is larger than the number of tensors to be processed by the regularization processing, each tensor to be processed by the fidelity processing is smaller in size than a tensor to be processed by the regularization processing, and the tensor to be processed by the regularization processing is a combination of the tensors generated by the fidelity processing, and
the fidelity processing and the regularization processing are alternately executed.

5. A non-transitory computer-readable medium having computer-executable instructions that, upon execution of the instructions by a processor of a computer, cause the computer to function as the learning device according to claim 1.
